(19) United States
(12) Patent Application Publication
(10) Pub. No.: US 2025/0055151 A1
(43) Pub. Date: Feb. 13, 2025

(54) BATTERY PACK AND BATTERY ASSEMBLY

(71) Applicant: Ford Global Technologies, LLC, Dearborn, MI (US)

(72) Inventors: Larry Wang, Nanjing (CN); Shiwu Hao, Nanjing (CN); Fei Gao, Hefei (CN); Peng Fei He, Nanjing (CN)

(21) Appl. No.: 18/782,493

(22) Filed: Jul. 24, 2024

(30) Foreign Application Priority Data
Aug. 7, 2023 (CN) 2023221079624

(51) Int. Cl. H01M 50/517; H01M 50/249; H01M 50/258; H01M 50/291

(52) U.S. Cl. CPC H01M 50/517; H01M 50/249; H01M 50/258; H01M 50/291

(57) ABSTRACT

A battery pack comprises a first battery module, a second battery module and at least one connecting piece. The first battery module has a first side plate and a first side beam portion arranged on the first side plate. The second battery module is adjacent to the first battery module in a first direction. The second battery module has a second side plate and a second side beam portion arranged on the second side plate. The first side beam portion and the second side beam portion are at least partially longitudinally overlapped in an installation position. The at least one connecting piece passes through the first side beam portion and the second side beam portion to form a first side beam.

### CROSS-REFERENCE TO RELATED APPLICATIONS

This disclosure claims priority to Chinese Patent Application No. 2023221079624, which was filed on 7 Aug. 2023 and is incorporated herein by reference in its entirety.

### TECHNICAL FIELD

The present disclosure generally relates to the technical field of vehicle batteries, and more specifically relates to a battery pack and a battery assembly.

### BACKGROUND

With the development of consumer demand for fuel conservation and environmental protection in current market, various new energy vehicles, including but not limited to pure electric vehicles (BEVs), hybrid electric vehicles (HEVs), and plug-in hybrid electric vehicles (PHEVs), are becoming increasingly popular. These new energy vehicles will become one of the future development trends in automotive industry due to their advantages in fuel conservation, environmental friendliness, and economy.

With the increasing demand of users for range of electric vehicles, the range that can be achieved by a single charge of the electric vehicles is also constantly increasing. Increasing a number of battery cells can lead to higher energy density within a given battery pack without increasing a volume of the battery pack.

### SUMMARY

The present disclosure summarizes various aspects of the embodiments and should not be used to limit the claims. Other implementations are contemplated in accordance with the techniques described herein, as will be apparent upon examination of the following drawings and detailed description, and such implementations are intended to be within the scope of this application.

According to one aspect of the present disclosure, a battery pack is provided, comprising: a first battery module having a first side plate and a first side beam portion arranged on the first side plate; a second battery module being adjacent to the first battery module in a first direction and having a second side plate and a second side beam portion arranged on the second side plate, wherein the first side beam portion and the second side beam portion are at least partially longitudinally overlapped in an installation position; and at least one connecting piece that passes through the first side beam portion and the second side beam portion to form a first side beam.

In one embodiment, the battery pack comprises: a third battery module being opposite to the first battery module in a second direction and having a third side plate and a third side beam portion arranged on the third side plate; a fourth battery module being adjacent to the third battery module in the first direction and having a fourth side plate and a fourth side beam portion arranged on the fourth side plate, wherein the fourth side beam portion and the third side beam portion are at least partially longitudinally overlapped in the installation position; at least one connecting piece that passes through the third side beam portion and the fourth side beam portion to form a second side beam; and a first connecting bracket that connects the first side beam and the second side beam.

In another embodiment, the first battery module, the second battery module, the third battery module, and the fourth battery module respectively include a first end plate, a second end plate, a third end plate, and a fourth end plate, the first end plate is disposed opposite the third end plate and the second end plate is disposed opposite the fourth end plate in the second direction; and the first connecting bracket is connected to the first end plate, the second end plate, the third end plate, and the fourth end plate.

In yet another embodiment, the battery pack comprises: a second connecting bracket that connects the first side beam or the second side beam to a tray and/or a cover of the battery pack.

In yet another embodiment, the first connecting bracket includes a first connecting portion, the first connecting portion has a first connecting arm and a second connecting arm that extends parallel to each other in the first direction, the first connecting arm connects the first end plate and the second end plate, and the second connecting arm connects the third end plate and the fourth end plate.

In yet another embodiment, the first connecting bracket includes a second connecting portion, the second connecting portion has a third connecting arm that extends in the second direction and connects the first side beam and the second side beam.

In yet another embodiment, the battery module has a modular formed shell, the shell comprises at least a first side plate and a second side plate disposed opposite to each other, and side beam portions formed on the first side plate and the second side plate respectively, each of the side beam portions is arranged to be at least partially longitudinally overlapped with the adjacent side beam portion in the first direction.

In yet another embodiment, a preset gap is formed in the second direction between the first connecting arm and the second connecting arm.

According to another aspect of the present disclosure, a battery assembly is provided, comprising: multiple battery modules arranged along a first direction to form a first battery module array, each with a side plate and a first side beam portion formed on the side plate; each two of the side plates of the multiple battery modules being adjacent in the first direction; wherein the first side beam portions on the adjacent two side plates are at least partially longitudinally overlapped in an installation position and multiple first side beams are formed by passing connecting pieces through the overlapped side beam portions.

In one embodiment, the battery assembly comprises: a second battery module array composed of multiple battery modules, each of the multiple battery modules has a side plate and a second side beam portion formed on the side plate, each two of the side plates of the multiple battery modules being adjacent in the first direction; wherein the second side beam portions on the adjacent two side plates are at least partially longitudinally overlapped in the installation position and multiple second side beams are formed by passing connecting pieces through the overlapped side beams portions; the second battery module array is arranged parallel to the first battery module array at a preset interval, and the multiple battery modules in the first battery module array and the second battery module array each have multiple sets of opposite end plates; and multiple connecting brackets, each of which connects to at least the first side beams, the second side beams, and two sets of opposite end plates.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 is a side view schematic diagram of adjacent battery modules of a prior art battery pack in an assembled state;

FIG. 2 is an expanded, schematic diagram of a battery pack according to an embodiment of the present disclosure;

FIG. 3 is a side view schematic diagram of adjacent battery modules in an assembled state according to an embodiment of the present disclosure;

FIG. 4 is a top view schematic diagram of a connecting bracket according to an embodiment of the present disclosure;

FIG. 5 is a top view schematic diagram of a connecting bracket according to another embodiment of the present disclosure;

FIG. 6 is a top view schematic diagram of a battery pack in an assembled state according to an embodiment of the present disclosure; and

FIG. 7 is a sectional schematic diagram of a battery module connected to a tray according to an embodiment of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical applications. However, various combinations and modifications of the features consistent with the teachings of the present disclosure may be desired for certain particular applications or implementations.

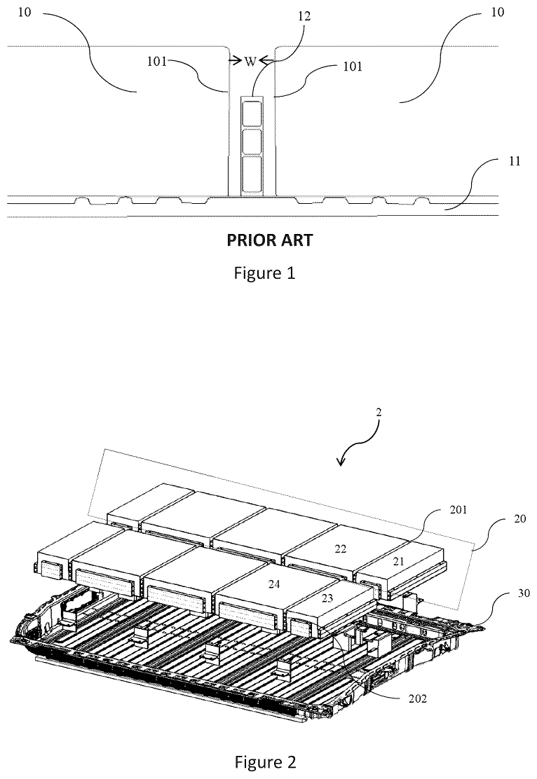

As shown in FIG. 1, which illustrates a side view schematic diagram of adjacent battery modules 10 in a battery pack using a reinforcement structure in prior art, the battery modules 10 are arranged on a tray 11 of the battery pack or battery assembly, the tray 11 has a crossbeam 12, the crossbeam 12 extends in a transverse direction of the tray 11 as a reinforcement structure for the tray and is located between side plates 101 of the adjacent battery modules 10. In the above arrangement of the prior art, the crossbeam 12 serves as the reinforcement structure for the tray 11, increasing a gap W between the battery modules 10, thereby reducing the number of the battery modules that can be accommodated under the same volume. In the current situation, where more and more battery modules 10 need to be accommodated in the battery pack, the larger gap can become significant. In addition, the separation of adjacent battery modules 10 by the crossbeam 12 can affect the overall structural stiffness of the battery pack.

Therefore, in some embodiments of the present application, a battery pack is provided, which can increase the structural stiffness and integration of the battery pack, while reducing the use of additional reinforcement structures and saving assembly space.

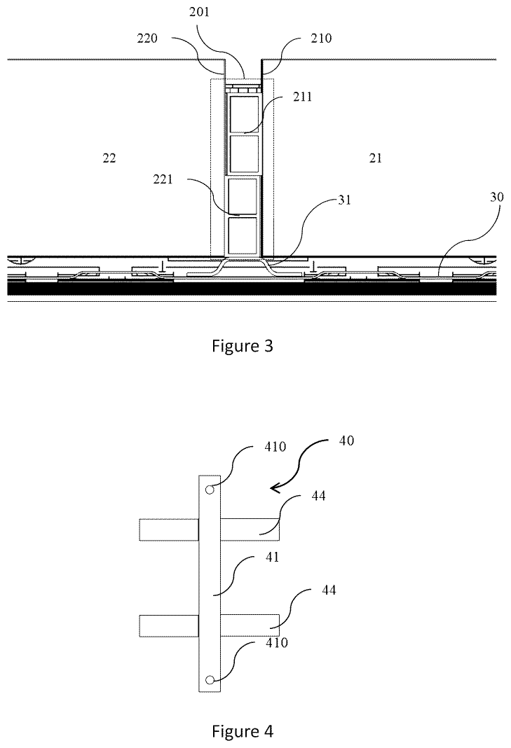

As shown in FIG. 2, in one embodiment, the present disclosure provides a battery pack or battery assembly 2. In the embodiment shown in FIG. 2, the battery pack 2 includes two sets of battery module arrays 20 composed of multiple battery modules. The two sets of battery module arrays 20 are arranged parallel to each other in a first direction, that is, a length direction of a tray 30. Those skilled in the art can understand that the number of the battery module arrays 20 and the number of the battery modules in each set of battery module arrays 20 can be increased or decreased as needed. FIG. 3 shows a side view schematic diagram of two adjacent battery modules in an assembled state. Battery modules 21 and 22 in the embodiment shown in FIG. 3 are two battery modules adjacent in the first direction in the battery module arrays 20 of FIG. 2. As shown in FIGS. 2 and 3, the battery module 21 has a side plate 210 having a side beam portion 211 that extends in a second direction, that is, a width direction of the tray 30. Similarly, the battery module 22 adjacent to the battery module 21 in the first direction has a side plate 220 adjacent to the side plate 210, and the side plate 220 also has a side beam portion 221 that extends in the second direction.

When the battery modules 21 and 22 are in an installation position shown in FIG. 3, the side beam portions 211 and 221 overlap at least partially in the first direction. The overlapping parts have a width that can be determined based on the layout of the entire battery pack and the requirements for assembly tolerances. The side beam portions 211 and 221 that partially overlap can be connected together through a connecting piece. The connecting piece passes through the two side beam portions in a height direction, to form a side beam 201 on adjacent side walls of the battery modules 21 and 22. In one embodiment, the side beam 201 can have a hollow structure. The hollow structure extends through the entire side beam 201 in the second direction, thereby reducing the weight of the entire battery modules. In one embodiment, the connecting piece can be a long bolt, which can pass through the two side beam portions in the height direction and then be connected to a bracket 31 protruding from the bottom of the tray 30, thereby fixing the side beam to the bottom of the tray 30.

It can be understood that the side beam portions 211 and 221 are respectively formed at the upper and lower parts of the side plates 210 and 220, so that they cooperate with each other in shape to achieve stacking in the height direction. When the battery module array 20 is formed by the multiple battery modules, the side beam portions on the two side plates of each battery module can be formed at the upper and lower parts of the side plates respectively, so that the side beam portions of the multiple battery modules forming the battery module array 20 can cooperate with each other to form the side beam.

In one embodiment, the battery module has a shell that is formed in a modular manner. The shell may include two opposite side plates and two end plates. Each side plate has a side beam portion, and the side beam portions of the two opposite side plates are formed in different positions on each side plate in a longitudinal direction, so that each side beam portion can match the shape and position of the side beam portion on the side plate of the adjacent shell in the first direction, in order to achieve at least partial overlapping in the longitudinal direction. Through the arrangement of the side beam portion on the modular shell mentioned above, when the battery pack in the technical solution of the present disclosure is formed by the battery modules, the side beam portions on the side plates of the adjacent battery modules can be conveniently cooperate with each other, without the need to distinguish whether the side beam portions on adjacent shells can match, thereby reducing production time and build complexity.

According to the description of the stacking and connection method between the side beam portions on the side plates of the adjacent battery modules shown in FIG. 3, in the embodiment of the present disclosure, the side beam portions of the side plates of the adjacent battery modules can be connected by the above method to form the battery pack 2 composed of two rows of battery module arrays 20 as shown in FIG. 2. Continuing with the embodiment shown in FIG. 2, battery modules 23 and 24 are also adjacent in the first direction, and adjacent side plates thereof also have side beam portions that are the same or similar to that of the battery modules 21 and 22, the two side beam portions are partially overlapped, and passed through by a connecting piece to form a side beam 202.

In this embodiment, the battery module 23 is disposed opposite the battery module 21 in the second direction. Similarly, the battery module 24 is disposed opposite the battery module 22 in the second direction.

In one embodiment, as shown in FIG. 4, a first connecting bracket 40 for connecting the side beams 201 and 202 is shown. The first connecting bracket 40 has a connecting arm 41 that extends in the second direction and a supporting portion 44 that extends in the second direction and height direction, wherein the supporting portion 44 is fixedly or detachably connected to the bottom of the tray 30 to support the first connecting bracket 40.

In one embodiment, the connecting arm 41 has two ends respectively provided with connecting holes 410, via which the side beams 201 and 202 are connected to the connecting arm 41 of the first connecting bracket 40 through the connecting piece, thereby connecting the battery modules 21, 22, 23, and 24 together to form a “−” shaped connection structure, and improving the integration and structural stiffness of the battery modules in the battery pack. In another embodiment, the connecting arm 41 of the first connecting bracket 40 are also provided with the connecting holes 410, via which the battery modules 21, 22, 23, and 24 can be connected to the connecting arm 41 through welding, adhesive, or snap structures.

Continuing with reference to FIGS. 2 and 5, the first connecting bracket 40 according to another embodiment of the present disclosure is shown. As shown in FIG. 5, in addition to the connecting arm 41 that extends in the second direction and a supporting portion 44 that extends in the second direction and height direction, the first connecting bracket 40 also has connecting arms 42 and 43 that extend parallel to each other in the first direction. In one embodiment of the present disclosure, connecting holes 420 and 430 are respectively provided on ends of both sides of the connecting arms 42 and 43. In one embodiment of the present disclosure, the battery modules 21, 22, 23, and 24 respectively have end plates 212, 222, 231, and 241, wherein the end plates 212 and 231 are disposed opposite to each other and adjacent to each other, and the end plates 222 and 241 are also disposed opposite to each other and adjacent to each other. The second connecting arm 42 connects the end plate 212 and the end plate 231 together through the connecting hole 420 and the connecting piece—in this embodiment, a long bolt, while the connecting arm 43 parallel to the connecting arm 42 connects the end plate 222 and the end plate 241 together through the connecting hole 430 and the connecting piece. As a result, in addition to the side beams 201 and 202 of the battery modules 21, 22, 23, and 24 being connected through the connecting arm 41, the end plates 212, 222, 231, and 241 are further connected through the connecting arms 42 and 43, making the integrated structure of the battery modules 21, 22, 23, and 24 forming a “ [symbol] ” shaped arrangement more stable.

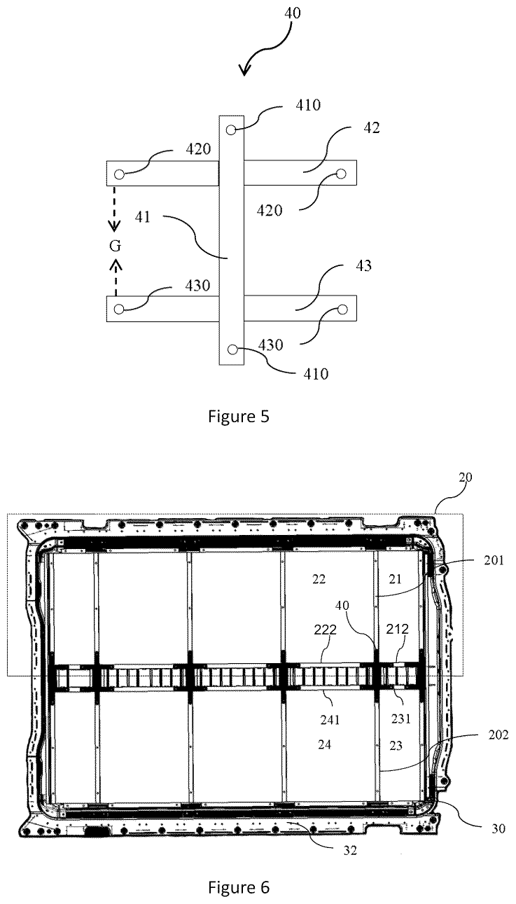

From the top view of the connection structure of the battery pack in an assembled state in FIG. 6, it can be seen that every four battery modules arranged in a “ [symbol] ” shaped form a “ [symbol] ” shaped connection structure at the center through the first connecting bracket 40 of the present disclosure, achieving the overall stable connection of the battery modules. It can be understood that in other embodiments of the present disclosure, the connecting arms 42 and 43 can also be arranged at an angle rather than parallel to adapt to the position of the end plate they need to be connected to.

Continuing to refer to FIG. 6, it can be seen that there is a gap between the parallel battery module arrays 20 which is achieved by a preset gap G between the connecting arm 42 and the connecting arm 43 of the first connecting bracket 40 as shown in FIG. 5. The preset gap G between the parallel battery module arrays 20 provides a certain amount of space between the assembled battery module arrays 20 of the battery pack, which facilitates the arrangement of wiring harnesses. On the other hand, when the battery pack 2 of the vehicle experiences a force in the second direction, the preset gap G can allow the battery pack to reserve a certain amount of space for possible deformation during the compression process, which can reduce the compression of the battery module arrays 20 during the deformation process of the battery pack.

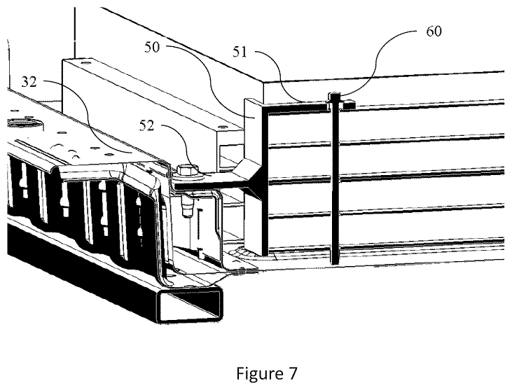

Next, combining FIGS. 2 and 7, in one embodiment of the present disclosure, the battery pack comprises two rows of battery module arrays 20. The portion of the battery module array 20 adjacent to a side edge 32 of the tray 30 is fixedly connected to the side edge 32 through a second connecting bracket 50. It can be understood that in other embodiments, the second connecting bracket 50 can also connect the battery module arrays 20 to other rigid structures, such as packaging the battery pack cover in conjunction with the tray 30. In this embodiment, the second connecting bracket 50 is fixed to the bracket 31 at the bottom of the tray 30 through a connecting pieces—in this embodiment, a long bolt 60, that passes through a hole on a connecting leg 51 of the second connecting bracket 50 and simultaneously passes through the two stacked side beam portions on the side plates of the battery modules. At the same time, a fixing leg 52 of the second connecting bracket 50 is connected to the side edge 32 of the tray 30 through a fastener, thereby fixing the battery module arrays 20 more stably to the tray 30 of the battery pack to reduce vibration during vehicle movement.

As described in the above embodiments of the present disclosure, the first connecting bracket is used to form a “−” or “ [symbol] ” shaped connection structure between the battery modules, thereby forming an integrated structure for the multiple battery modules in the battery pack. At the same time, the side beams are formed by longitudinally overlapping the side beam portions formed on the side plates of the battery modules can save space required by the crossbeam structure, enhances the integration of the battery pack and the structural rigidity of the battery pack. In addition, the outer end of the battery modules are fixed to the bottom and side edge of the tray by the second connecting brackets, reducing the vibration of the battery pack and improving stability.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure. It should be understood by those skilled in the art that the above discussion to any embodiment is only illustrative, and is not intended to imply that the disclosed scope of the embodiments of the present disclosure (including claims) is limited to these examples.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack, comprising:
a first battery module having a first side plate and a first side beam portion arranged on the first side plate;
a second battery module being adjacent to the first battery module in a first direction and having a second side plate and a second side beam portion arranged on the second side plate, wherein the first side beam portion and the second side beam portion are at least partially longitudinally overlapped in an installation position; and
at least one connecting piece that passes through the first side beam portion and the second side beam portion to form a first side beam.

2. The battery pack according to claim 1, comprising:
a third battery module being opposite to the first battery module in a second direction and having a third side plate and a third side beam portion arranged on the third side plate;
a fourth battery module being adjacent to the third battery module in the first direction and having a fourth side plate and a fourth side beam portion arranged on the fourth side plate, wherein the fourth side beam portion and the third side beam portion are at least partially longitudinally overlapped in the installation position;
at least one connecting piece that passes through the third side beam portion and the fourth side beam portion to form a second side beam; and
a first connecting bracket that connects the first side beam and the second side beam.

3. The battery pack according to claim 2, wherein the first battery module, the second battery module, the third battery module, and the fourth battery module respectively include a first end plate, a second end plate, a third end plate, and a fourth end plate, the first end plate is disposed opposite the third end plate and the second end plate is disposed opposite the fourth end plate in the second direction,
wherein the first connecting bracket is connected to the first end plate, the second end plate, the third end plate, and the fourth end plate.

4. The battery pack according to claim 3, wherein the first connecting bracket includes a first connecting portion, the first connecting portion has a first connecting arm and a second connecting arm that extend parallel to each other in the first direction, the first connecting arm connects the first end plate and the second end plate, and the second connecting arm connects the third end plate and the fourth end plate.

5. The battery pack according to claim 4, wherein a preset gap is formed in the second direction between the first connecting arm and the second connecting arm.

6. The battery pack according to claim 2, further comprising a second connecting bracket that connects the first side beam or the second side beam to a tray of the battery pack.

7. The battery pack according to claim 2, further comprising a second connecting bracket that connects the first side beam or the second side beam to a cover of the battery pack.

8. The battery pack according to claim 2, wherein the first connecting bracket includes a second connecting portion, the second connecting portion having a third connecting arm that extends in the second direction and connects the first side beam and the second side beam.

9. The battery pack according to claim 1, wherein the battery module has a modular formed shell, the shell comprises at least a first side plate and a second side plate disposed opposite to each other, and side beam portions formed on the first side plate and the second side plate respectively, each of the side beam portions is arranged to be at least partially longitudinally overlapped with the adjacent side beam portion in the first direction.

10. The battery pack according to claim 1, wherein the connecting piece is a bolt.

11. The battery pack according to claim 1, wherein the first side beam portion is stacked on the second side beam portion.

12. The battery pack according to claim 1, wherein the first side beam portion is vertically above the second side beam portion.

13. The battery pack according to claim 1, wherein the first side beam portion and the second side beam portion are each hollow.

14. A battery assembly, comprising:
multiple battery modules arranged along a first direction to form a first battery module array, each with a side plate and a first side beam portion formed on the side plate; and
each two of the side plates of the multiple battery modules being adjacent in the first direction,
wherein the first side beam portions on the adjacent two side plates are at least partially longitudinally overlapped in an installation position and multiple first side beams are formed by passing connecting pieces through the overlapped side beam portions.

15. The battery assembly according to claim 14, comprising a second battery module array composed of multiple battery modules, each of the multiple battery modules has a side plate and a second side beam portion formed on the side plate,
each two of the side plates of the multiple battery modules being adjacent in the first direction;
wherein the second side beam portions on the adjacent two side plates are at least partially longitudinally overlapped in the installation position and multiple second side beams are formed by passing connecting pieces through the overlapped side beams portions;
the second battery module array is arranged parallel to the first battery module array at a preset interval, and the multiple battery modules in the first battery module array and the second battery module array each have multiple sets of opposite end plates; and
multiple connecting brackets, each of which connects at least the first side beams, the second side beams, and two sets of opposite end plates.

16. The battery assembly according to claim 15, further comprising a plurality of fasteners that connect each of the multiple connecting brackets to at least the first side beams, the second side beams, and two sets of opposite end plates.

17. The battery assembly according to claim 16, wherein the first side beam portion and the second side beam portion are each hollow.

18. The battery assembly according to claim 14, wherein the first side beam portions on the adjacent two side plates are stacked.

19. The battery assembly according to claim 14, wherein the connecting pieces are bolts.
